(19) United States
(12) Patent Application Publication
(10) Pub. No.: US 2025/0371395 A1
(43) Pub. Date: Dec. 4, 2025

(54) MODULATION OF A TWO-LEVEL-SYSTEM LANDSCAPE PER EXPERIMENT

(71) Applicant: International Business Machines Corporation, Armonk, NY (US)

(72) Inventors: Andrew Dane, Tarrytown, NY (US); Karthik Balakrishnan, Scarsdale, NY (US); Isaac Lauer, Chappaqua, NY (US); Jerry David Tersoff, Rockland, NY (US); Youngseok Kim, Montvale, NJ (US); Abhinav Kandala, Yorktown Heights, NY (US); Jeffrey W. Sleight, Ridgefield, CT (US)

(21) Appl. No.: 18/678,182

(22) Filed: May 30, 2024

(51) Int. Cl. G06N 10/20

(52) U.S. Cl. CPC G06N 10/20

(57) ABSTRACT

One or more systems, devices, computer program products and/or computer-implemented methods of use provided herein relate to buffers for streaming in quantum-centric supercomputing. A system can comprise a memory that can store computer-executable components. The system can further comprise a processor that executes at least one of the computer executable components that can execute a quantum circuit to obtain measurements of a qubit. The at least one of the computer executable components can further modulate, via a control two-level system (TLS) knob, a TLS landscape of a quantum processor between successive executions of the quantum circuit.

### BACKGROUND

The subject disclosure relates to two-level-system (TLS) quantum noise, and more specifically to modulation of a TLS landscape per experiment.

Accurate estimation of observables within a quantum circuit is a fundamental aspect for many quantum algorithms. That is, when quantum circuits are executed on quantum processors, the quantum circuits yield observable estimates of properties or quantities of a quantum system. When executed on noisy quantum processors, though, the quantum circuits yield observable estimates that deviate from ideal values. Accordingly, mitigation of the impact of such noise can help obtain unbiased estimates. However, achieving accurate measurements and device stability for various quantum applications can be challenging due to noise fluctuations caused by interactions between superconducting qubits and TLSs.

The above-described background description is merely intended to provide a contextual overview regarding the TLS landscape in quantum computing and is not intended to be exhaustive.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable modulation of the two-level-system (TLS) interaction landscape between successive executions are discussed.

According to an embodiment, a system is provided. The system can comprise a memory that can store computer-executable components. The system can further comprise a processor that executes at least one of the computer executable components that can execute a quantum circuit to obtain measurements of a qubit. The at least one of the computer executable components can further modulate, via a control TLS knob, a TLS landscape of a quantum processor between successive executions of the quantum circuit.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate modulation of a qubit-TLS interaction landscape between successive executions in accordance with one or more embodiments described herein.

FIG. 2 illustrates a block diagram of an example, non-limiting quantum system that can at least partially facilitate modulation of a qubit-TLS interaction landscape between successive executions in accordance with one or more embodiments described herein.

FIG. 3 illustrates a diagram of an example, non-limiting implementation of periodic modulation of the control TLS knob during execution of the quantum circuit in accordance with one or more embodiments described herein.

FIG. 4 illustrates a diagram of an example, non-limiting implementation of discrete modulation of the control TLS knob during execution of the quantum circuit in accordance with one or more embodiments described herein.

FIG. 5 illustrates a diagram of an example, non-limiting graph of selecting calibration parameters of the control TLS knob for execution of the quantum circuit.

FIG. 6 illustrates a flow diagram of an example, non-limiting method that can facilitate modulation of a qubit-TLS interaction landscape between successive executions in accordance with one or more embodiments described herein.

FIG. 7 illustrates a flow diagram of an example, non-limiting method that can facilitate modulation of a qubit-TLS interaction landscape between successive executions in accordance with one or more embodiments described herein.

FIG. 8 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer-executable components. The system can further comprise a processor that executes at least one of the computer executable components that can execute a quantum circuit to obtain measurements of a qubit. The at least one of the computer executable components can further modulate, via a control TLS knob, a TLS landscape of a quantum processor between successive executions of the quantum circuit. Such embodiments of the system can provide a number of advantages, including reducing computational overhead, increasing stability of error mitigation, reducing computational time of quantum experiments, reducing quantum noise, and enabling scalability of quantum systems.

In one or more embodiments of the aforementioned system, the at least one of the computer executable components can further supply a periodic modulation that continuously varies of the control TLS knob during the successive executions of the quantum circuit based on a period of the periodic modulation. Such embodiments of the system provide the advantage of reducing computational time of quantum experiments and computational overhead.

In some embodiments of the aforementioned system, the at least one of the computer executable components can further discretely change parameters of the control TLS knob between the successive executions of the quantum circuit. Such embodiments of the system provide the advantage of stabilizing qubit operation and stabilizing qubits against background fluctuations of TLSs.

In various embodiments of the aforementioned system, the at least one of the computer executable components can further select, based on a metric, subsets of the measurements to determine subsets of the parameters of the control TLS knob, and execute the quantum circuit using the subsets of the parameters. Such embodiments of the system provide the advantages of reducing qubit noise, error sources, and stabilizing qubits against background fluctuations of TLSs.

In some embodiments of the aforementioned system, wherein the period is determined by an experimental repetition rate at which the measurements are obtained, gate length, or a shape of modulation on the TLS landscape. Such embodiments of the system provide the advantage of stabilizing qubits against background fluctuations of TLSs.

In one or more embodiments of the aforementioned system, wherein the periodic modulation of the control TLS knob is non-commensurate relative to the experimental repetition rate. Such embodiments of the system provide the advantage of increasing stability of observable estimates in quantum experiments.

In one or more embodiments of the aforementioned system, the at least one of the computer executable components can further modulate the TLS landscape of one or more qubits of the quantum circuit via one or more respective control TLS knobs, wherein parameters of the periodic modulation and the shape of modulation on the TLS landscape is independent between the one or more respective control TLS knobs. Such embodiments of the system provide the advantage of reducing qubit noise fluctuation, enabling scalability to larger sets of quantum circuits for quantum applications. The stabilized noise provided by such embodiments further provides the advantage of obtaining more accurate solutions for a given quantum application via quantum error mitigation.

In one or more embodiments of the aforementioned system, wherein the measurements from each of the successive executions over the TLS landscape at different modulations are accumulated. Such embodiments of the system provide the advantages of reducing qubit noise and stabilizing noise models for execution in quantum experiments.

According to some embodiments, the above-described computer system can be implemented as a computer-implemented method or as a computer program product.

Reliable operation in quantum computing can depend on characterizations of qubits to assess stability or performance. Characterization of qubits can provide insights into various parameters, such as coherence times, gate fidelity, and error rates, which are essential for optimizing algorithms, identifying hardware limitations, and advancing quantum technology (e.g., quantum error mitigation, qubit fabrication). For example, quantum error mitigation (e.g., probabilistic error cancellation) relies on the stability of learned noise models. However, there can be various sources of error (e.g., noise model drift) in observable estimation of the qubits. Such sources of error can cause unstable results, and thus can limit how many quantum circuits can be executed and accordingly how many noise models can be reliably learned. For example, the decoherence time of qubits is subject to time fluctuations due to TLSs and defects that reside in dielectrics that are part of the qubit devices. In particular, the diffusion of TLS transition frequencies over time can significantly contribute to fluctuations in qubit relaxation times. Such temporal fluctuations can cover vast ranges of timescales, causing characterization of the qubits to be difficult, as measuring the decoherence time of a qubit once is insufficient to accurately and meaningfully characterize the qubit device. In TLSs, the qubit-TLS interaction can degrade reliability and effectiveness of error mitigation techniques (e.g., can result in nonphysical observable estimates). As another example, such sources of error can cause inaccurate observable measurements for qubit characterization, limiting abilities to determine or refine qubit fabrication techniques.

The TLS landscape can be changed via a control TLS knob to mitigate such errors. However, modulating the TLS landscape over an entire experiment using only one control TLS knob value can lead to oversimplified control and bias. Such an approach may fail to capture the complex and multifaceted nature of quantum systems, limiting the ability to optimize performance or explore alternative configurations of the quantum devices. Thus, an efficient method for stabilizing qubits against temporal fluctuations in a TLS based on modulation of the TLS landscape between successive executions can be desirable.

Various embodiments of the present disclosure can be implemented to produce a solution to one or more of the problems discussed above. Embodiments described herein include systems, computer-implemented methods, and computer program products that can enable modulation of a qubit-TLS interaction landscape. For example, in various embodiments, a periodic modulation can be supplied to a control TLS knob during execution of a quantum circuit to effectively sample different TLS environments for each repetition in the execution over the duration of data collection. In various embodiments, the periodic modulation can periodically vary during execution based on a period of the periodic modulation. Furthermore, to enable the different TLS environments for each experiment repetition, the periodic modulation can be non-commensurate to an experiment repetition rate of the quantum experiment. As another example, in various embodiments, discrete modulation of can be supplied to the control TLS knob during execution of the quantum circuit to also sample different TLS environments for each repetition. In some embodiments, calibrated parameters of the control TLS knob can be determined based on a metric of observed measurables and used to calibrate the control TLS knob to implement the calibrated parameters for discrete modulation of the TLS landscape. This can allow the control TLS knob to only utilize parameters that will cause stable or desirable results of the metric.

In various embodiments, more than one control TLS knob can be supplied continuous or discrete modulation to enable different TLS environments for each experiment repetition of more than one qubit. In some embodiments, the qubit-TLS interaction landscape of each of the more than one qubit can be independently modulated. In other words, the qubit-TLS interaction landscape can be individually controlled in multi-qubit scenarios.

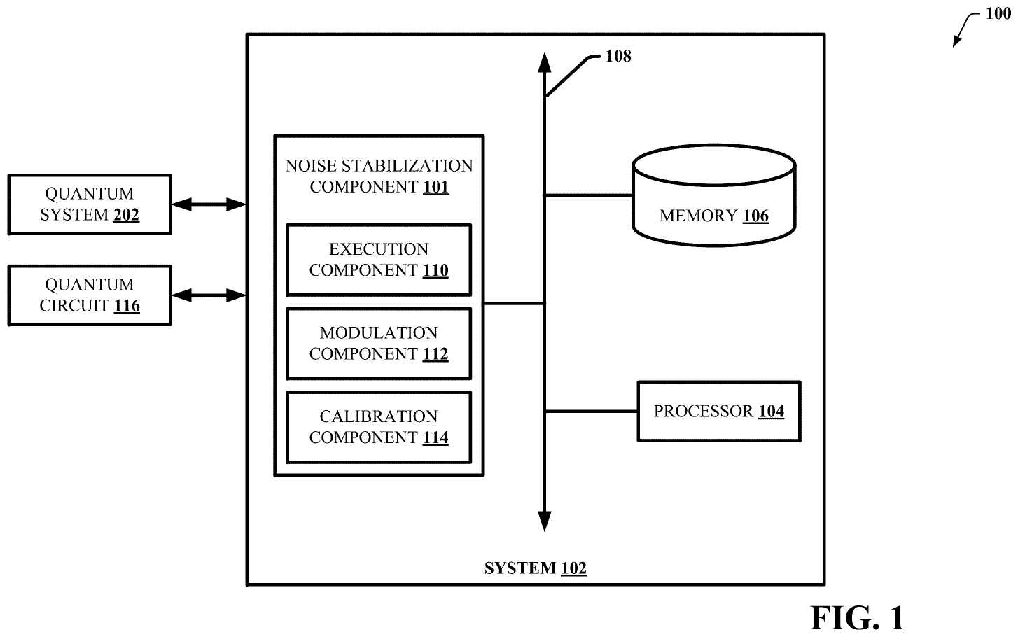

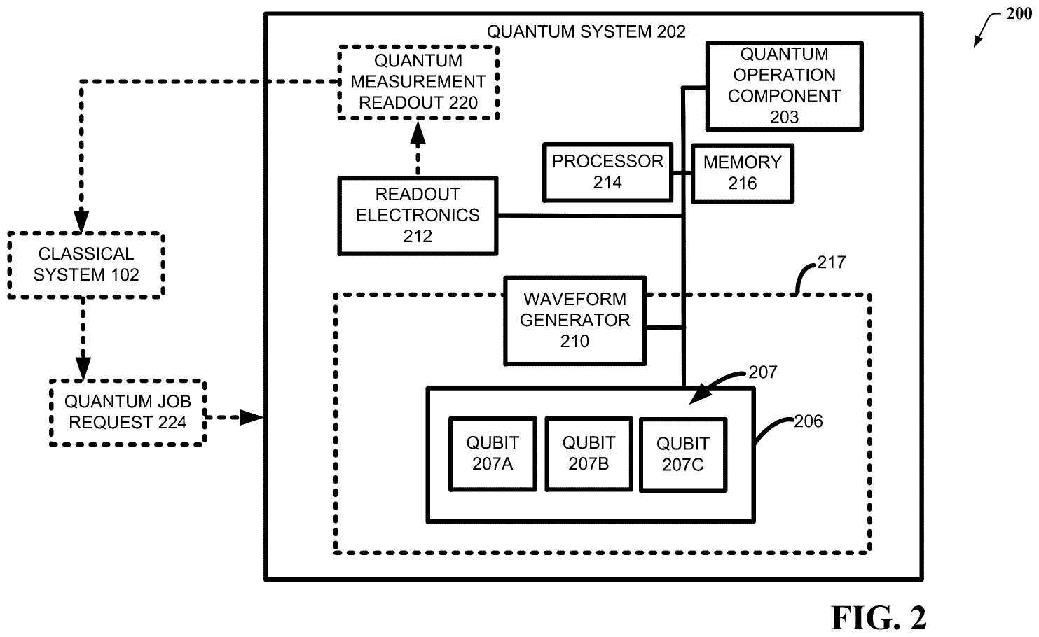

FIG. 1 illustrates a block diagram of an example, non-limiting system 100 that can facilitate modulation of a qubit-TLS interaction landscape between successive executions in accordance with one or more embodiments described herein. That is, the non-limiting system 100 can facilitate modulation of a qubit-TLS interaction landscape, in combination with employment of a quantum system 202 (FIG. 2).

Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise noise stabilization component 101, processor 104, memory 106, system bus 108, execution component 110, and modulation component 112.

The system 100 and/or the components of the system 100 can be employed to use hardware and/or software to solve problems that are highly technical in nature (e.g., related to quantum error mitigation, TLS modulation, quantum noise models, qubit fabrication, qubit characterization, etc.), that are not abstract and that cannot be performed as a set of mental acts by a human. Further, some of the processes performed may be performed by specialized computers for carrying out defined tasks related to quantum systems. The system 100 and/or components of the system can be employed to solve new problems that arise through advancements in technologies mentioned above, computer architecture, and/or the like. The system 100 can provide technical improvements to qubit characterization by stabilizing qubit-TLS interactions, improving efficiency of qubit characterization, and/or reducing computational overhead etc.

Discussion turns briefly to processor 104, memory 106 and bus 108 of system 100. For example, in one or more embodiments, the system 100 can comprise processor 104 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 100 can comprise a computer-readable memory (e.g., memory 106) that can be operably connected to the processor 104. Memory 106 can store computer-executable instructions that, upon execution by processor 104, can cause processor 104 and/or one or more other components of system 100 (e.g., noise stabilization component 101, execution component 110, and/or modulation component 112) to perform one or more actions. In one or more embodiments, memory 106 can store computer-executable components (e.g., noise stabilization component 101, execution component 110, and/or modulation component 112).

System 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 104 and/or memory 106 described above, system 100 can comprise one or more computer and/or machine readable, writable and/or executable components and/or instructions that, when executed by processor 104, can enable performance of one or more operations defined by such component(s) and/or instruction(s).

In various embodiments, system 100 can access a quantum circuit 116, and execution component 110 can execute the quantum circuit 116 on a quantum processor (e.g. processor 214). In various aspects, quantum circuit 116 can comprise any suitable number of qubits, wherein the qubits can be superconducting qubits. Superconducting qubits are a basic and fundamental element of superconducting quantum computers or superconducting quantum systems. In various cases, the qubits can be physically instantiated in any suitable way. For example, the qubits can be realized as an anharmonic electrical resonator (e.g., a resonant circuit that deviates from ideal harmonic behavior and exhibits non-linear relationships between frequency and energy levels). In various embodiments, the qubits can be implemented using TLSs (e.g., quantum system with two distinguishable energy levels that can represent computations basis states of a qubit). Transitions between the two basis states can often be induced by external factors such as electromagnetic radiation, temperature changes, modification of the strain in material, or interactions within the quantum system.

In various aspects, it can be desirable to characterize one or more qubits of the quantum circuit 116. In various embodiments, execution component 110 can repeat execution of quantum circuit 116 any suitable number of times (e.g., 1000 repetitions) to obtain measurements of a qubit of the quantum circuit 116 to characterize the qubit. In other words, execution component 110 can perform any suitable number of successive executions of the quantum circuit 116. As a non-limiting example, it can be desirable to measure the energy relaxation time (e.g., decoherence time) of a qubit, denoted by T1. The energy relaxation time of a qubit is a basic coherence characterization of a qubit, representing a timescale over which the qubit's quantum state remains coherent before losing phase relationship due to interactions with its environment. As another example, Randomized Benchmarking (RB) can be used to characterize performance of single-qubit or two-qubit gates in quantum circuit 116 by performing a series of randomized gate sequences to measure fidelity of the resulting states. In any case, the execution component 110 can execute quantum circuit 116 to obtain observable measures to characterize the qubits. In various embodiments, a measurement can be obtained for each repetition of execution (e.g., shot) of the quantum circuit 116.

In various embodiments, the modulation component 112 can stabilize the measurements obtained by successively executing the quantum circuit 116 over a number of repetitions. More specifically, modulation component 112 can supply a periodic modulation that continuously varies to a control TLS knob. In some instances, the periodic modulation can be a quasi-static periodic modulation (e.g., gradual and continuous adjustment of parameters with minimal change over time). The control TLS knob represents parameters that can manipulate the qubit-TLS interaction landscape of the quantum processor. The control TLS knob can be implemented in any suitable format.

As a non-limiting example, the control TLS knob can be implemented via piezo electronics to provide lattice deformation. Specifically, shape and dimensions of lattice structures surrounding the TLS can be precisely controlled with piezo electronics. This is due to a unique property of piezoelectric materials, wherein the piezoelectric materials deform when subjected to an electric field or generate an electric field when mechanically deformed.

As another non-limiting example, the control TLS knob can be implemented with an additional bias pad (e.g., electrodes) to supply an electric field. The bias pads can be used to apply localized electric fields or potentials to specific regions of the TLS environment, allowing for precise control over the TLS energy levels, transition frequencies, or coherence properties. In various embodiments, by adjusting voltages applied to the bias pads, the electric fields experienced by the TLSs can be modulated.

As yet another non-limiting example, the control TLS knob can be implemented by supplying off-resonant stark shift tone to the qubit of interest to shift frequency of the qubit. The off-resonant stark shift tone leverages the Stark effect (e.g., the energy levels of a quantum system are shifted in the presence of an electric field, even when the frequency of the field is detuned from the natural resonance frequency of the system) by applying an external electromagnetic field to shift the frequency of the qubit.

In any case, the control TLS knob can facilitate modulation of the qubit-TLS interaction landscape by adjusting various aspects of the qubit-TLS interaction landscape. In particular, the control TLS knob can facilitate modulation of the qubit-TLS interaction landscape wherein such modulation causes each repetition of execution of the quantum circuit 116 to sample a different TLS environment for data collection (e.g., obtaining of measurements). Therefore, the measurements can be stabilized by accumulating and averaging it over the different TLS environments.

In various embodiments, the calibration component 114 can determine a set of calibration parameters of the control TLS knob for modulating the TLS landscape for which the control TLS knob can implement during execution to omit parameters of the control TLS knob that exhibit unstable or undesirable observed measurables.

In various embodiments, the methods described herein can be extended to multi-qubit scenarios. More specifically, more than one control TLS knob can be implemented to independently control more than one respective qubit. Each of the more than one control TLS knob can individually control and modulate the qubit-TLS interaction landscape for the respective qubit. Such embodiment can enable effective and efficient characterization of a quantum device by obtaining measurements of the more than one qubit of a device in shorter durations than current methods, and thus better enable understanding of device fabrication. For example, it can be efficiently determined which qubits perform better to understand which materials, processes and geometries are desirable. Furthermore,

System 100 can unlock new capabilities in quantum computing. For example, system 100 can provide for efficient execution for characterizing qubits and reducing noise. Further, system 100 can allow real-time decision making in quantum computing, including qubit characterization, quantum error mitigation and quantum error correction. System 100 can additionally provide improved hardware efficiency and faster development by reducing execution time or reducing the number of devices needed to characterize the quantum system. In general, system 100 can enable efficient and stabilized qubit characterization against background fluctuations and temporal fluctuations of TLSs.

Turning to FIG. 2, one or more embodiments described herein can include one or more devices, systems and/or apparatuses that can provide a process to facilitate modulation of the TLS landscape. Accordingly, at FIG. 2, illustrated is a block diagram of an example, non- limiting system 200 that can at least partially facilitate such a process. While referring here to one or more processes, facilitations and/or uses of the non-limiting system 200, description provided herein, both above and below, also can be relevant to one or more other non-limiting systems described herein, such as the non-limiting systems 100.

As illustrated at FIG. 2, the non-limiting system 200 can comprise a quantum system 202 that can be employed with or separate from the classical system 102.

Generally, the quantum system 202 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuity can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 220, can be responsive to the quantum job request 224 and associated input data and can be based at least in part on the input data, quantum functions and/or quantum computations.

In one or more embodiments, the quantum system 202 can comprise components, such as a quantum operation component 203, a quantum processor 206, pulse component 210 (e.g., a waveform generator) and/or a readout electronics 212 (e.g., readout component). In one or more other embodiments, the readout electronics 212 can be comprised at least partially by the classical system 102 and/or be external to the quantum system 202. The quantum processor 206 can comprise one or more, such as plural, qubits 207. Individual qubits 207A, 207B and 207C, for example, can be fixed frequency and/or single junction qubits, such as transmon qubits.

In one or more embodiments, a memory 216 and/or processor 214 can be associated with the quantum operation component 203, where suitable. The processor 214 can be any suitable processor. The processor 214 can generate one or more instructions for controlling the one or more processes of the quantum operation component 203.

The quantum operation component 203 can obtain (e.g., download, receive, search for and/or the like) a quantum job request 224 requesting execution of one or more quantum programs and/or a physical qubit layout. The quantum job request 224 can be provided in any suitable format, such as a text format, binary format and/or another suitable format. In one or more embodiments, the quantum job request 224 can be obtained by a component other than of the quantum system 202, such as a by a component of the classical system 102.

The quantum operation component 203 can determine mapping of one or more quantum logic circuits for executing a quantum program. In one or more embodiments, the quantum operation component 203 and/or quantum processor 206 can direct the waveform generator 210 to generate one or more pulses, tones, waveforms and/or the like to affect one or more qubits 207, such as in response to a quantum job request 224.

The waveform generator 210 can generally cause the quantum processor 206 to perform one or more quantum processes, calculations and/or measurements by creating a suitable electro-magnetic signal. For example, the waveform generator 210 can operate one or more qubit effectors, such as qubit oscillators, harmonic oscillators, pulse generators and/or the like to cause one or more pulses to stimulate and/or manipulate the state(s) of the one or more qubits 207 comprised by the quantum system 202.

The quantum processor 206 and a portion or all of the waveform generator 210 can be contained in a cryogenic environment, such as generated by a cryogenic environment 217, such as effected by a dilution refrigerator. Indeed, a signal can be generated by the waveform generator 210 to affect one or more of the plurality of qubits 207. Where the plurality of qubits 207 are superconducting qubits, cryogenic temperatures, such as about 4K or lower, can be employed for function of these physical qubits. Accordingly, one or more elements of the readout electronics 212 also can be constructed to perform at such cryogenic temperatures.

The readout electronics 212, or at least a portion thereof, can be contained in the cryogenic environment 217, such as for reading a state, frequency and/or other characteristic of qubit, excited, decaying or otherwise.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

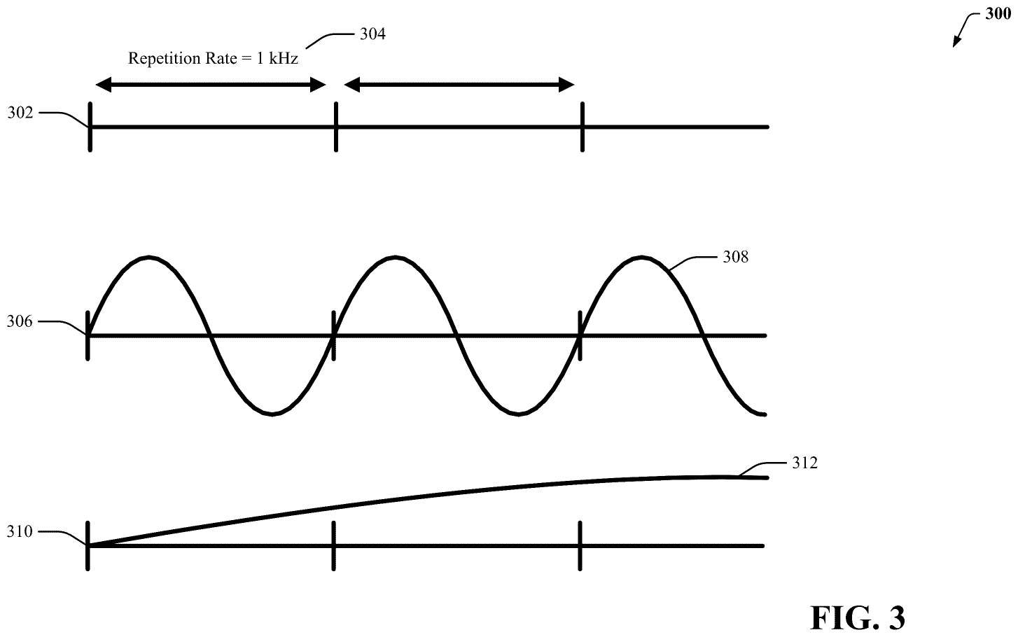

FIG. 3 illustrates a diagram of an example, non-limiting implementation 300 of periodic modulation of the control TLS knob during execution of the quantum circuit in accordance with one or more embodiments described herein. One or more embodiments described with reference to FIG. 3 can be performed by one or more components of FIG. 1 and/or FIG. 2. Repetitive description of like elements and/or processes employed in respective embodiments is omitted for sake of brevity.

In various embodiments, the execution component 110 can execute the quantum circuit 116 to obtain the measurements of the qubit at an experimental repetition rate 304. For instance, as shown at timescale 302, the experimental repetition rate 304 can be 1 kHz. Although, the experimental repetition rate 304 can be any suitable rate at which the execution is repeated. For instance, in various embodiments, the experimental repetition rate 304 can range from frequencies between 1000 Hertz and a thousandth of a Hertz. In various embodiments, the periodic modulation of the control TLS knob can be non-commensurate relative to the experimental repetition rate 304 to enable sampling of a different TLS environment for each repetition. In other words, the periodic modulation of the control TLS knob can share no common basis, measure, or standard of comparison with the experimental repetition rate. To achieve this, the periodic modulation of the TLS control knob can periodically vary based on a period of the periodic modulation. For example, time scale 310 depicts a periodic modulation 312 that continuously varies and is non-commensurate with experimental repetition rate 304. Conversely, as shown by timescale 306, a periodic modulation 308 can be commensurate with experimental repetition rate 304. For example, periodic modulation 308 depicts a sinusoidal shape of modulation on the TLS landscape, wherein a period of the sinusoidal shape of modulation aligns with the experimental repetition rate 304 (e.g., the period of the sinusoidal shape of modulation equals the experimental repetition rate 304). In some cases, the period does not necessarily have to equal the experimental repetition rate 304 to be commensurate with experimental repetition rate 304 and may just consist of a consistent relationship. However, in any case, a periodic modulation 308 that is commensurate with experimental repetition rate 304 will not enable sampling of a different TLS environment for each repetition, and accordingly, will not result in stabilization of the observed measurables. Therefore, it can be desirable to supply periodic modulation 312 of the control TLS knob that is non-commensurate with experimental repetition rate 304.

Accordingly, in various embodiments, the modulation component 112 can define the period of the periodic modulation based on the experimental repetition rate 304. Similarly, modulation component 112 can define the period of the periodic modulation based on a gate length (e.g., duration or time interval during which a quantum gate operation is applied to a qubit or set of qubits) that influences timing of when the measurements can be performed in the quantum circuit 116. In various cases, the TLS landscape can be modulated per gate within a range of 50 to 100 nanoseconds. In other words, the periodic modulation can be quasi-static on the timescale of gates but fast in the timescale of the quantum experiment. In either instance, the modulation component 112 can define the period of the periodic modulation such that each measurement is obtained under a different TLS landscape.

In various embodiments, the modulation component 112 can define the period of the periodic modulation based on the shape of modulation (e.g. sinusoidal modulation, sawtooth modulation, triangular modulation) on the TLS landscape. For example, periodic modulation 312 comprises a sinusoidal shape of modulation, similar to periodic modulation 308, however, the period of periodic modulation 312 is significantly larger than the period of periodic modulation 308. That is, the period of periodic modulation 312 is determined so each cycle of the periodic modulation 312 does not occur or align with the experimental repetition rate 304.

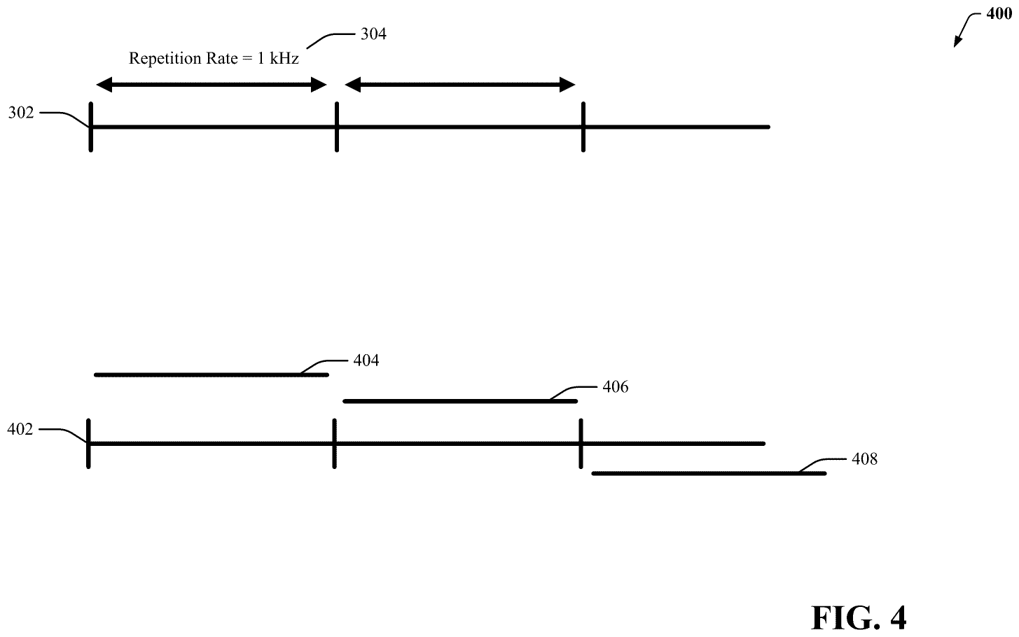

FIG. 4 illustrates a diagram of an example, non-limiting implementation 400 of discrete modulation of the control TLS knob during execution of the quantum circuit in accordance with one or more embodiments described herein. One or more embodiments described with reference to FIG. 4 can be performed by one or more components of FIG. 1. Repetitive description of like elements and/or processes employed in respective embodiments is omitted for sake of brevity.

Alternatively to periodic modulation as discussed herein, in various embodiments the modulation component 112 can change a setting of the control TLS knob between successive executions to achieve sampling of different TLS landscapes. In various embodiments, to change the setting of the control TLS knob between successive executions, the modulation component can discretely change parameters of the control TLS knob between successive executions. In other words, alternatively to supplying a periodic modulation of the control TLS knob during execution to achieve sampling of different TLS landscapes, the modulation component 112 can discretely modulate the TLS landscape, via the control TLS knob, between each repetition of execution to achieve sampling of different TLS landscapes. In particular, the modulation component 112 can supply the discrete modulation of the control TLS knob on the TLS landscape by discretely changing parameters of the control TLS knob. Doing so can cause a value of the control TLS knob to remain consistent throughout each repetition of execution. Therefore, following all successive executions, the measurements can be obtained for different values and settings of the control TLS knob, and thus be obtained under different TLS landscapes.

For example, as shown by timescale 402, each experiment repetition can consist of a different discrete modulation. More specifically, as depicted by timescale 402, the first repetition of execution can be executed under discrete modulation 404. Following the first repetition, the modulation component 112 can change parameters of the control TLS knob to a discrete modulation 406, before the second repetition of execution, comprising a different discrete value of the control TLS knob than discrete modulation 404. Therefore, for the duration of the second repetition, the quantum circuit 116 will be executed at the different discrete value of the control TLS knob, and thus under a different TLS landscape than in the first repetition. Similarly, following the second repetition, the modulation component 112 can change parameters of the control TLS knob to a discrete modulation 408 before the third repetition of execution. Therefore, for the duration of the third repetition, the quantum circuit 116 will be executed at the different discrete value of the control TLS knob, and thus under a different TLS landscape than in the first repetition and second repetition. In various embodiments, modulation component 112 can supply the discrete modulation of the control TLS knob based on the experimental repetition rate 304.

The one or more embodiments described herein can enable efficient capturing of all possible measurements (e.g., all possible T₁ times) of the quantum system by sampling numerous TLS configurations (e.g., configurations that are allowed by a control electrode) in a short duration of time. Therefore, a harmonic and stabilized mean of all possible T₁ times can be accumulated. Such embodiments can have many practical applications, such as qubit coherence research, wherein measuring T₁ (e.g., or other measurables) with current methods can be time-consuming (e.g., hours, days, weeks) while the TLS naturally diffuses in and out of resonance with the qubit.

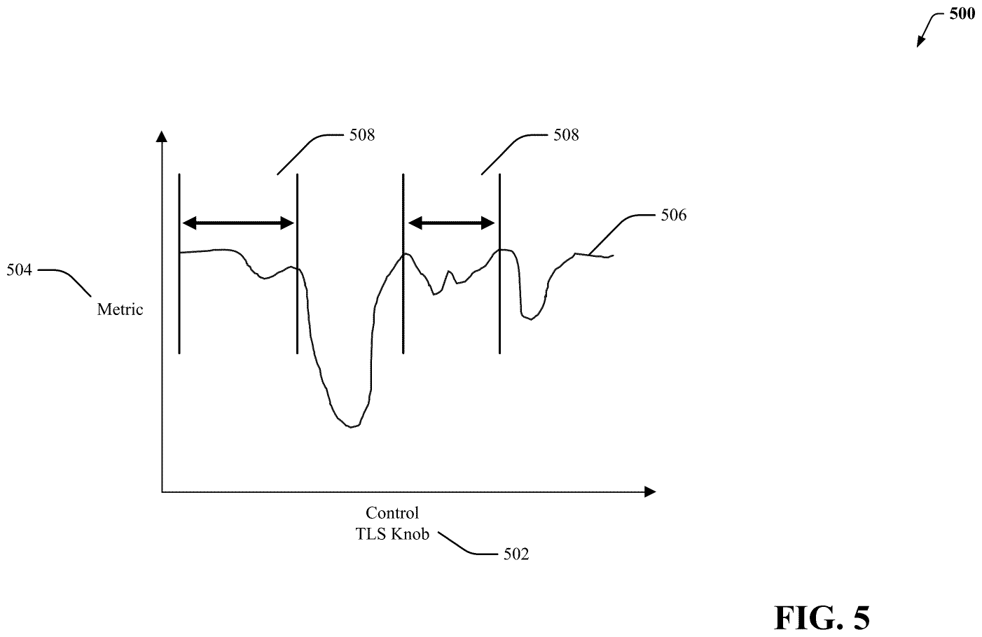

FIG. 5 illustrates a diagram of an example, non-limiting graph 500 of selecting calibration parameters of the control TLS knob for execution of the quantum circuit. One or more embodiments described with reference to FIG. 5 can be performed by one or more components of FIG. 1. Repetitive description of like elements and/or processes employed in respective embodiments is omitted for sake of brevity.

In various embodiments, the calibration component 114 can select, based on a metric, subsets of the measurements to determine subsets of the parameters of the control TLS knob to be used during execution of the quantum circuit. More specifically, the calibration component 114 can omit settings of the control TLS knob that produce undesirable observable measurements. For instance, as shown in non-limiting graph 500, the execution component 110 can execute quantum circuit 116 over values 502 of the control TLS knob. Accordingly, measurements 506 can be obtained. Based on metric 504, subsets of the measurements 508 can be selected. Specifically, subsets of the measurements 508 that are desirable based on the metric can be selected by calibration component 114. For instance, based on measurements of T₁, the metric 504 can define a range for which values of T₁ are desirable or stable (e.g., higher ranges of T₁ are desirable). Thus, the calibration component 114 can determine subsets of the values 502 of the control TLS knob that produce the measurements within the defined range. In various embodiments, the calibration component 114 can provide modulation component 112 the subsets of the values 502 for modulating, via the control TLS knob, the TLS landscape during execution of the quantum circuit 116. Therefore, upon execution of the quantum circuit 116, the TLS landscape can be modulated only with control TLS knob parameters that produce further stable or desirable results.

The various embodiments described herein can provide a number of advantages. For example, in a quantum experiment, the quantum circuit 116 can be implemented on a quantum device, wherein each qubit-TLS interaction can be independently controlled via more than one respective control TLS knob. In the experiment, measurements of energy relaxation time T₁ of a qubit can be obtained under modulation of a control parameter. In such quantum experiment, when no modulation of the TLS landscape is utilized, significant fluctuations and lack of stability over time can occur, proving challenging to characterize T₁ of the qubit without execution of the quantum circuit 116 over an extensive duration of time to determine an estimate of a central behavior of the device (e.g., computing a median or average over the measurements).

Further, utilizing a control TLS knob fixed at one point throughout the executions can also exhibit outliers in a significant deviation from the expected observables. Conversely, utilizing methods described herein, significant increases in stability of T₁ over time can be achieved. Specifically, the methods described herein are able to minimize the impact of temporal fluctuations of the qubit-TLS interaction on the observed measurements. This is achievable by obtaining the measurements over different TLS landscapes via continuous or discrete modulation between successive executions to average T₁ over the different TLS landscapes. Note that, although the herein disclosure mainly describes stabilization over energy relaxation time T₁ of a qubit, the herein methods can be applied to any other measurement or property that can be estimated of the qubit. Further, although the herein disclosure mainly describes stabilization of measurements as a function of time, the herein methods are not limited to such applications. For example, T₁ can be measured and as a function of, but is not limited to, temperature to reduce noise.

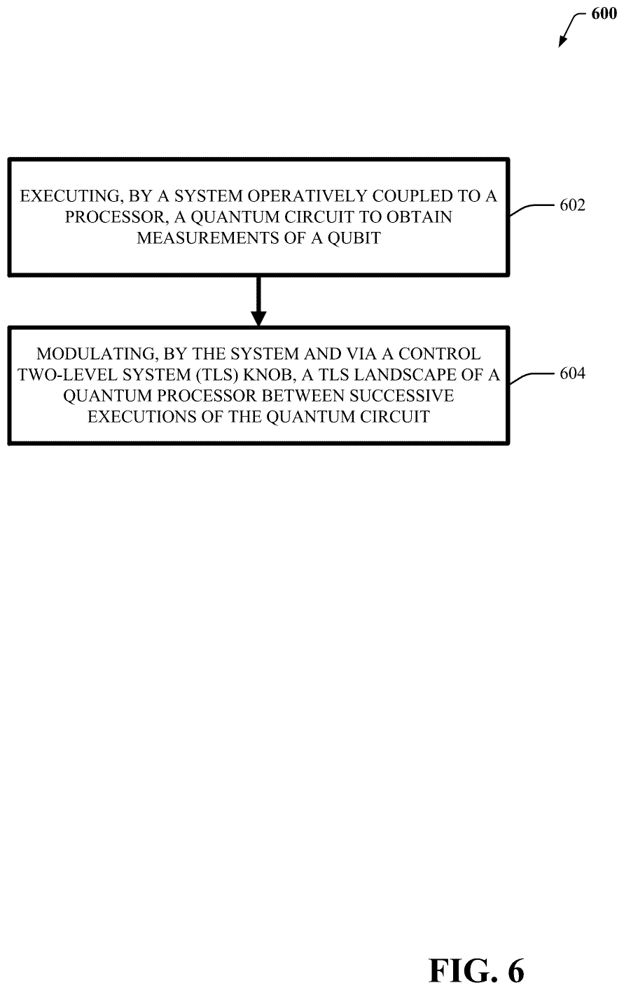

FIG. 6 illustrates a flow diagram of an example, non-limiting method that can facilitate modulation of a qubit-TLS interaction landscape between successive executions in accordance with one or more embodiments described herein. Repetitive description of like elements and/or processes employed in respective embodiments is omitted for sake of brevity.

At 602, the non-limiting method 600 can comprise executing (e.g., by execution component 110), by a system operatively coupled to processor, a quantum circuit to obtain measurements of a qubit.

At 604, the non-limiting method 600 can comprise modulating (e.g., by modulation component 112), by the system and via a control two-level system (TLS) knob, a TLS landscape of a quantum processor between successive executions of the quantum circuit. In various embodiments, the modulation component 112 can modulate the TLS landscape to sample different TLS environments for each repetition of execution by supplying a continuous and periodically varying modulation via the control TLS knob. In various aspects, the periodic modulation can be non-commensurate to the experimental repetition rate at which the measurements are obtained to enable the sampling of different TLS environments. Alternatively, the modulation component 112 can discretely change parameters of the control TLS knob between successive executions to cause each repetition to sample a different TLS environment.

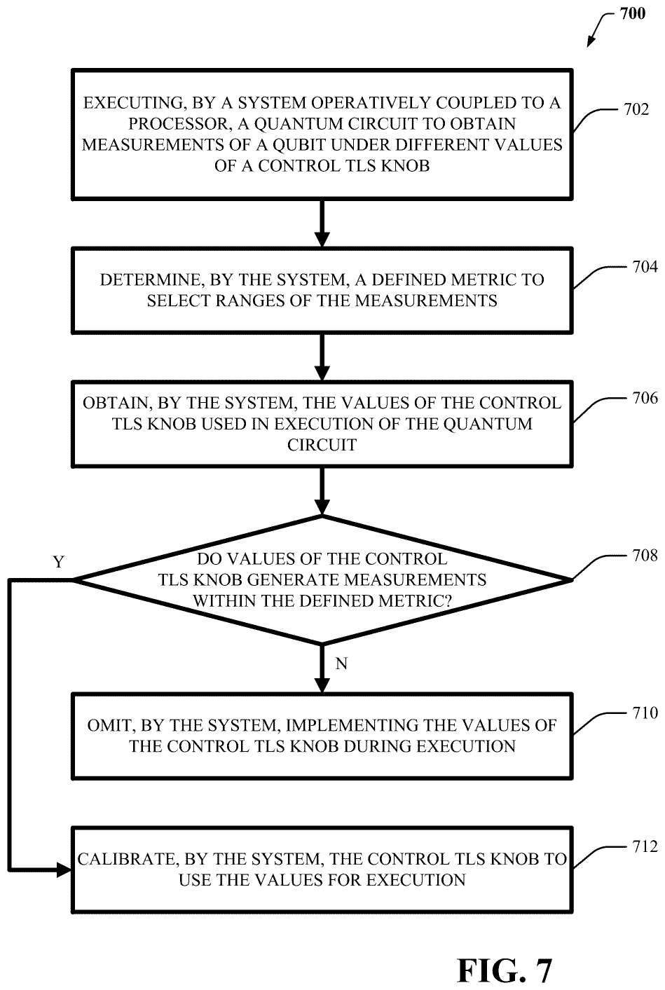

FIG. 7 illustrates a flow diagram of an example, non-limiting method 700 that can facilitate modulation of a qubit-TLS interaction landscape between successive executions in accordance with one or more embodiments described herein. Repetitive description of like elements and/or processes employed in respective embodiments is omitted for sake of brevity.

At 702, the non-limiting method 700 can comprise executing (e.g., by execution component 110), by a system operatively coupled to processor, a quantum circuit to obtain measurements of a qubit under different values of a control TLS knob.

At 704, the non-limiting method 700 can comprise determining (e.g., by calibration component 114), by the system, a defined metric to select subsets of the measurements.

At 706, the non-limiting method 700 can comprise obtaining (e.g., by calibration component 114), by the system, the values of the control TLS knob used in execution of the quantum circuit.

At 708, the non-limiting method 700 can comprise determining (e.g., by calibration component 114), by the system, if the values of the control TLS knob generate measurements within the defined metric.

If no, at 710, the non-limiting method 700 can comprise omitting (e.g., by calibration component 114), by the system, implementing the values if the control TLS knob during execution.

If yes, at 712, the non-limiting method 700 can comprise calibrating (e.g., by calibration component 114), by the system, the control TLS knob to use the values for execution.

As a non-limiting example, the control TLS knob can also be implemented as a microwave tone amplitude. As another non-limiting example, the control TLS knob can be implemented by supplying off-resonant stark shift tones to the qubit to shift qubit frequency. Therefore, the control TLS knob can be adjusted or controlled via voltage modulation. In various aspects, the execution component 110 can execute the quantum circuit 116 under different voltages of the control TLS knob. For instance, periodic modulation, via the control TLS knob, can be supplied to the TLS landscape at low frequencies (e.g., less than one Hertz) with large amplitude sinusoidal modulation onto a gate electrode during a qubit operation. This can enable each execution repetition to be supplied with an effectively randomized voltage. Accordingly, the calibration component 114 can determine which voltages supplied by the control TLS knob produce desirable observable estimates. For example, which of the observable estimates that are desirable can be determined based on a defined metric. For example, if T₁ is the obtained measurements, the defined metric can identify specific ranges of T₁ that are desirable (e.g., 180 to 200 μs). Accordingly, based on the measurements of the qubit and the defined metric, the calibration component 114 can select subsets of the values of the control TLS knob (e.g., voltages) that produce measurements of T₁ within the desired range. Such subsets of the values can be used as calibration parameters for execution of the quantum circuit 116. In other words, the execution component 110 can execute the quantum circuit while the modulation component 112 supplies, via the control TLS knob, only the voltages within the subsets for modulation of the TLS landscape to obtain higher stability.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively stream quantum information for real-time decision making in quantum-centric supercomputing as the one or more embodiments described herein can enable this process. And, neither can the human mind nor a human with pen and paper monitor results generated in a buffering environment based on a release criterion, as conducted by one or more embodiments described herein.

In summary, various embodiments herein can provide a framework and protocol for transmitting calculations between quantum computers and classical computers. In some embodiments, approaches described herein can converge to a particular precision by increasing the number of shots, executions or operator measurements of a quantum circuit. This can allow noise due to an inherent probabilistic nature of quantum computing to be automatically managed without input from the user. As such, various embodiments herein can allow controlling statistical noise through a release criterion of a convergence level. In other embodiments, the approaches described herein can use efficient measurement bases to more efficiently measure each of the measurement bases to estimate an expectation value within a particular precision. In general, various embodiments herein can release a quantum computation upon fulfilling a release criterion. Depending on the application, the release criterion can be a particular precision, a time window, convergence, the size of the memory or dataset, whether enough gates have been received to form a dense circuit layer, whether all expectation values of interest have been received, or whether certain quantum states have been stored, etc.

Embodiments discussed herein can provide a number of advantages to quantum computing systems, including efficient and speedy transmission of payloads between modules to allow for streaming data for real-time decision making in quantum-centric supercomputing, improved QPU utilization by minimizing compilation at an end point to a quantum hardware, and faster development of quantum computing products with a flexible and powerful quantum-centric software framework. In the future, embodiments of the present disclosure can be extended to multiplexed inputs and/or outputs, and quantum memory and processing for quantum-to-quantum buffering. Streaming of data provided by embodiments of the present disclosure can also be explored in the future for protocols for maintaining security when communicating with external nodes, adapting existing classical protocols for quantum data, and communicating with layers of stack at higher levels of abstraction.

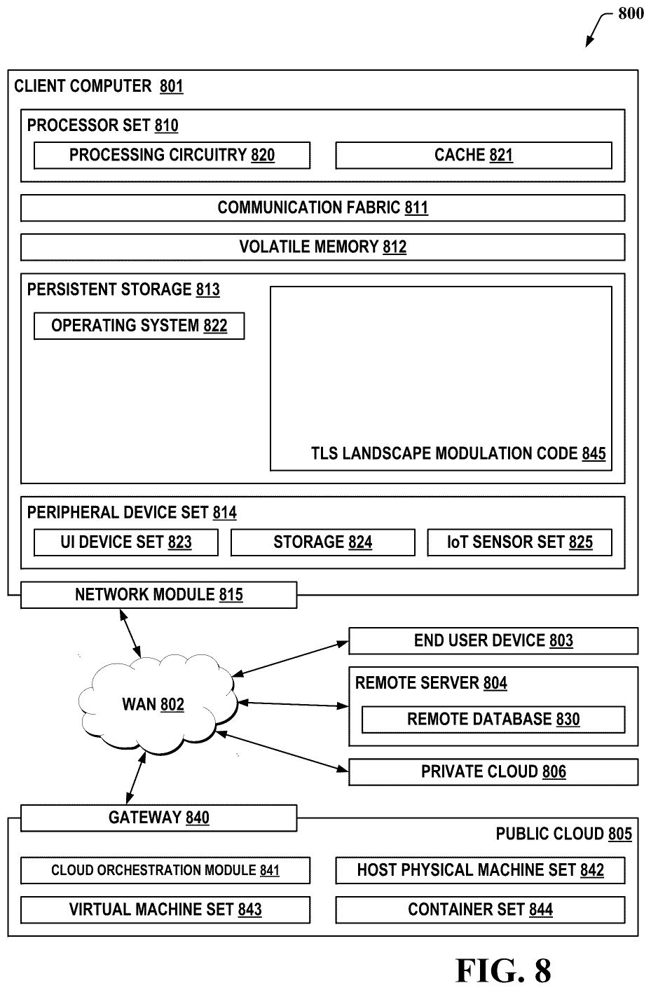

FIG. 8 illustrates a block diagram of an example, non-limiting operating environment 800 in which one or more embodiments described herein can be facilitated. FIG. 8 and the following discussion are intended to provide a general description of a suitable operating environment 800 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as TLS landscape modulation code 845. In addition to block 845, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 845, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 845 in persistent storage 813.

COMMUNICATION FABRIC 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in block 845 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes at least one of the computer executable components that:
execute a quantum circuit to obtain measurements of a qubit; and
modulate, via a control two-level system (TLS) knob, a TLS landscape of a quantum processor between successive executions of the quantum circuit.

2. The system of claim 1, wherein the at least one of the computer executable components further:
supply a periodic modulation that continuously varies of the control TLS knob during the successive executions of the quantum circuit based on a period of the periodic modulation.

3. The system of claim 1, wherein the at least one of the computer executable components further:
discretely changes parameters of the control TLS knob between the successive executions of the quantum circuit.

4. The system of claim 3, wherein the at least one of the computer executable components further:
select, based on a metric, subsets of the measurements to determine subsets of the parameters of the control TLS knob; and
execute the quantum circuit using the subsets of the parameters.

5. The system of claim 2, wherein the period is determined by an experimental repetition rate at which the measurements are obtained, gate length, or a shape of modulation on the TLS landscape.

6. The system of claim 5, wherein the periodic modulation of the control TLS knob is non-commensurate relative to the experimental repetition rate.

7. The system of claim 5, wherein the at least one of the computer executable components further:
modulate the TLS landscape of one or more qubits of the quantum circuit via one or more respective control TLS knobs, wherein parameters of the periodic modulation and the shape of modulation on the TLS landscape is independent between the one or more respective control TLS knobs.

8. The system of claim 1, wherein the measurements from each of the successive executions over the TLS landscape at different modulations are accumulated.

9. A computer-implemented method, comprising:
executing, by a system operatively coupled to a processor, a quantum circuit to obtain measurements of a qubit; and
modulating, by the system and via a control two-level system (TLS) knob, a TLS landscape of a quantum processor between successive executions of the quantum circuit.

10. The computer-implemented method of claim 9, further comprising:
supplying, by the system, a periodic modulation that continuously varies of the control TLS knob during the successive executions of the quantum circuit based on a period of the periodic modulation.

11. The computer-implemented method of claim 9, wherein changing the setting of the control TLS knob comprises:
discretely changing parameters of the control TLS knob between the successive executions of the quantum circuit.

12. The computer-implemented method of claim 11, further comprising:
selecting, by the system, regions of a metric of the measurements to determine subsets of the parameters of the control TLS knob; and
executing, by the system, the quantum circuit using the subsets of the parameters.

13. The computer-implemented method of claim 10, wherein the period is determined by an experimental repetition rate at which the measurements are obtained, gate length, or a shape of modulation on the TLS landscape.

14. The computer-implemented method of claim 13, wherein the periodic modulation of the control TLS knob is non-commensurate relative to the experimental repetition rate.

15. The computer-implemented method of claim 13, further comprising:
modulating, by the system, the TLS landscape of one or more qubits of the quantum circuit via one or more respective control TLS knobs, wherein parameters of the periodic modulation and the shape of modulation on the TLS landscape is independent between the one or more respective control TLS knobs.

16. The computer-implemented method of claim 9, wherein the measurements from each of the successive executions over the TLS landscape at different modulations are accumulated.

17. A computer program product for stabilizing qubit noise, the computer program product comprising a computer readable storage medium having program instructions embodied therewith, the program instructions executable by a processor to cause the processor to:
execute, by the processor, a quantum circuit to obtain measurements of a qubit; and
modulate, by the processor and via a control two-level system (TLS) knob, a TLS landscape of a quantum processor between successive executions of the quantum circuit.

18. The computer program product of claim 17, the program instructions executable by the processor to further cause the processor to:
supply, by the processor, a periodic modulation that continuously varies of the control TLS knob during the successive executions of the quantum circuit based on a period of the periodic modulation.

19. The computer program product of claim 17, the program instructions executable by the processor to further cause the processor to:
discretely change parameters of the control TLS knob between the successive executions of the quantum circuit.

20. The computer program product of claim 18, wherein the periodic modulation of the control TLS knob is non-commensurate relative to an experimental repetition rate at which the measurements are obtained.
